(19) United States
(12) Patent Application Publication
(10) Pub. No.: US 2026/0204725 A1
(43) Pub. Date: Jul. 16, 2026

(54) CASE FOR SECONDARY BATTERY AND SECONDARY BATTERY INCLUDING THE CASE

(71) Applicant: SAMSUNG SDI CO., LTD., Yongin-si (KR)

(72) Inventor: Heejung KO, Yongin-si (KR)

(21) Appl. No.: 19/344,796

(22) Filed: Sep. 30, 2025

(30) Foreign Application Priority Data
Jan. 10, 2025 (KR) 10-2025-0004077

(51) Int. Cl. H01M 50/342; H01M 50/119; H01M 50/159; H01M 50/169; H01M 50/171

(52) U.S. Cl. CPC H01M 50/3425; H01M 50/119; H01M 50/159; H01M 50/169; H01M 50/171; H01M 2200/20

(57) ABSTRACT

A case for a secondary battery includes a body including a receiving portion configured to receive an electrode assembly and a flange portion extending from a perimeter of an open end of the receiving portion. A cover is coupled to the flange portion to seal the open end of the receiving portion. A bonding line is disposed on the flange portion and on the cover. The bonding line includes a venting portion configured to rupture when a predetermined internal pressure is reached in the sealed receiving portion.

### CROSS-REFERENCE TO RELATED APPLICATION

This present application claims priority to and the benefit under 35 U.S.C. § 119(a)-(d) of Korean Patent Application No. 10-2025-0004077, filed on January 10, 2025, in the Korean Intellectual Property Office, the entire disclosure of which is incorporated herein by reference.

### BACKGROUND

### FIELD

The present disclosure relates to a case for a secondary battery and a secondary battery including the case.

### DESCRIPTION OF RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When the secondary battery is exposed to a high-temperature environment or when a short circuit occurs, gas may be generated inside the case due to decomposition of the electrolyte and electrode reactions. As a result, the case may swell. Consequently, the case of the secondary battery may rupture, and ignition or explosion caused by thermal runaway may occur.

The above information disclosed in this Background section is for enhancement of understanding of the background of the present disclosure, and therefore, it may contain information that does not constitute related (or prior) art.

### SUMMARY

An objective of the present disclosure is to provide a case for a secondary battery and a secondary battery including the case that solves the above-described technical problems.

However, the technical problems to be solved by the present disclosure is not limited to the above problem, and other problems not mentioned herein, and aspects and features of the present disclosure that would address such problems, will be clearly understood by those skilled in the art from the description of the present disclosure below.

In some embodiments, a case for a secondary battery includes a body including a receiving portion configured to receive an electrode assembly and a flange portion extending from a perimeter of an open end of the receiving portion, a cover coupled to the flange portion to seal the open end of the receiving portion, and a bonding line disposed on the flange portion and on the cover, wherein the bonding line includes a venting portion configured to rupture when a predetermined internal pressure is reached in the sealed receiving portion.

In some embodiments, the bonding line may include a welded portion where the flange portion and the cover are welded to each other.

In some embodiments, the welded portion except for the venting portion may include a plurality of first weld beads, and the venting portion may include a plurality of second weld beads that have a weaker bonding strength than the plurality of first weld beads.

In some embodiments, a diameter of each of the second weld beads may be less than a diameter of each of the first weld beads.

In some embodiments, an interval between adjacent ones of the second weld beads may be greater than an interval between adjacent ones of the first weld beads.

In some embodiments, a depth of each of the second weld beads may be less than a welding depth of each of the first weld beads.

In some embodiments, the plurality of second weld beads may be formed in a single row and the plurality of first weld beads may be formed in two rows that are parallel to each other.

In some embodiments, the bonding line may include an adhesive portion in which the flange portion and the cover are bonded to each other by an adhesive.

In some embodiments, except for the venting portion, the adhesive portion may include a first adhesive layer, and the venting portion may include a second adhesive layer that has a melting point lower than a melting point of the first adhesive layer.

In some embodiments, the melting point of the second adhesive layer may be 120 °C to 150 °C.

In some embodiments, the adhesive portion may be electrically conductive.

In some embodiments, the bonding line may include an adhesive portion where the flange portion and the cover are bonded to each other by an adhesive, and a welded portion where the flange portion and the cover are welded to each other.

In some embodiments, except for the venting portion, the bonding line may include the adhesive portion and the welded portion, and the venting portion may include the adhesive portion.

In some embodiments, except for the venting portion, the welding portion may include a plurality of first weld beads, and the venting portion may include a plurality of second weld beads that have a weaker bonding strength than the plurality of first weld beads.

In some embodiments, except for the venting portion, the adhesive portion may include a first adhesive layer, and the venting portion may include a second adhesive layer that has a lower melting point lower than a melting point of the first adhesive layer.

In some embodiments, the body and the cover may be formed of a same metallic material.

In some embodiments, the metallic material may include stainless steel (SUS).

In some embodiments, a secondary battery includes an electrode assembly including a first electrode, a second electrode, and a separator disposed between the first electrode and the second electrode, and a case accommodating the electrode assembly, wherein the case includes a body including a receiving portion for accommodating the electrode assembly and a flange portion extending from a periphery of an open end of the receiving portion, a cover coupled with the flange portion to seal the open end of the receiving portion, and a bonding line disposed at the flange portion and the cover, wherein the bonding line includes a venting portion configured to be ruptured when a predetermined internal pressure is reached in the sealed receiving portion.

In some embodiments, the secondary battery may further include a first electrode terminal disposed on a side surface of the body and electrically connected to the first electrode, and a second electrode terminal disposed on the side surface of the body and electrically connected to the second electrode.

In some embodiments, the bonding line may include a welded portion where the flange portion and the cover are welded to each other.

According to some embodiments of the present disclosure, a case for a secondary battery and a secondary battery including the case can be provided, with the case being configured to prevent thermal runaway due to an increase in internal pressure caused by the abnormal behavior of the secondary battery without additional processing.

According to certain embodiments of the present disclosure, in the process of joining the body accommodating the electrode assembly of the secondary battery and the cover by welding or applying an adhesive, a vent can be formed by merely modifying part of the bonding line pattern.

However, aspects and features of the present disclosure are not limited to those described above, and other aspects and features not mentioned will be clearly understood by a person skilled in the art from the detailed description described below.

### BRIEF DESCRIPTION OF DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 is a schematic view of a case for a secondary battery according to an embodiment of the present disclosure.

FIG. 2 is a cross-sectional view of a transverse section of a case for a secondary battery according to an embodiment of the present disclosure and a cross-sectional view illustrating a bonding line of the case for the secondary battery.

FIG. 3 illustrates a case for a secondary battery according to embodiments of the present disclosure.

FIG. 4 illustrates a case for a secondary battery according to embodiments of the present disclosure.

FIG. 5 illustrates a case for a secondary battery according to embodiments of the present disclosure.

FIG. 6 illustrates a case for a secondary battery according to embodiments of the present disclosure.

FIG. 7 is a cross-sectional view of a transverse section of a case for a secondary battery according to an embodiment of the present disclosure and a cross-sectional view illustrating a bonding line of the case for the secondary battery.

FIG. 8 illustrates a case for a secondary battery according to embodiments of the present disclosure.

FIG. 9 is a cross-sectional view of a transverse section of a case for a secondary battery according to an embodiment of the present disclosure and a cross-sectional view illustrating a bonding line of the case for the secondary battery.

FIG. 10 illustrates a case for a secondary battery according to embodiments of the present disclosure.

FIG. 11 is a schematic view of a secondary battery according to an embodiment of the present disclosure.

FIG. 12 is a flowchart of a method of manufacturing a secondary battery according to the present disclosure.

FIG. 13 illustrates a step of welding a case for a secondary battery according to embodiments of the present disclosure.

FIG. 14 illustrates a step of cutting a flange portion according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, the element or layer may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to one or more embodiments of the present disclosure. Expressions such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5 % or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly linked, coupled, or connected to each other, or another component may be interposed between the components.

Throughout the specification, when “A and/or B” is stated, the phrase means A, B, or A and B unless otherwise stated. That is, “and/or” includes any or all combinations of the plurality of items enumerated. When “C to D” is stated, the phrase means greater than or equal to C and less than or equal to D unless otherwise specified.

The terms used in the present specification are provided to describe embodiments of the present disclosure and are not intended to limit the present disclosure.

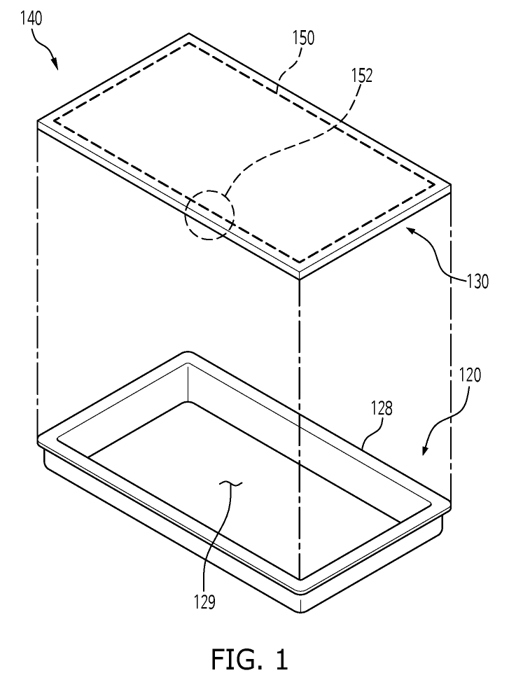

FIG. 1 is a schematic view of a case for a secondary battery according to an embodiment of the present disclosure.

Referring to FIG. 1, a case 140 for a secondary battery according to an embodiment of the present disclosure may include a body 120 having a receiving portion 129 designed to house an electrode assembly. The body 120 has an open end and a flange portion 128 extending from a perimeter of the opening. A cover 130 is coupled to the flange portion 128 so as to seal the open end of the receiving portion 129.

The case 140 forms an overall exterior of the secondary battery and may be formed of a conductive metal such as aluminum, an aluminum alloy, or nickel-plated steel. Specifically, the body 120 and the cover 130 may be formed of the same metallic material. The metallic material may include stainless steel (SUS) or aluminum (Al). However, these examples are illustrative, and the case 140 may be formed of various metallic materials that provide the mechanical strength and resistance to external impact required by the secondary battery.

The receiving portion 129 of the body 120 may be configured to receive an electrode assembly 110. The receiving portion 129 may be configured to provide an internal space for receiving the electrode assembly 110 by a press-working process or the like. A planar shape of the receiving portion 129 of the body 120 may be, for example, a rectangle, but the present disclosure is not limited thereto.

The cover 130 may be configured as a plate disposed on the flange portion 128 of the body 120 to seal the open end of the receiving portion 129. For example, the cover 130 may be formed as a plate having a size large enough to cover the flange portion 128 so that a lower surface of the cover 130 and an upper surface of the flange portion 128 contact each other. When the flange portion 128 and the cover 130 are coupled, the body 120 and the cover 130 may form a single structure.

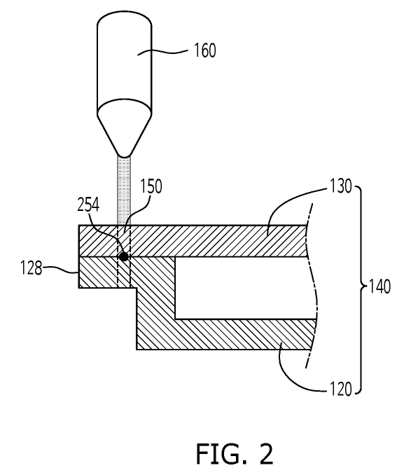

The case 140 for a secondary battery may include a bonding line 150 disposed on the flange portion 128 and on the cover 130 corresponding to the flange portion 128. The bonding line 150 is a region in which the flange portion 128 and the cover 130 are coupled to each other to seal the receiving portion 129. For example, the bonding line 150 may include a welded portion formed by welding the flange portion 128 and the cover 130 to each other by means of a laser welder. Additionally or alternatively, the bonding line 150 may include an adhesive portion bonding the flange portion 128 and the cover 130 to each other. The bonding line 150 may be formed along edges of the cover 130 and the flange portion 128. The bonding line 150 will be described below with reference to FIGS. 2 to 10.

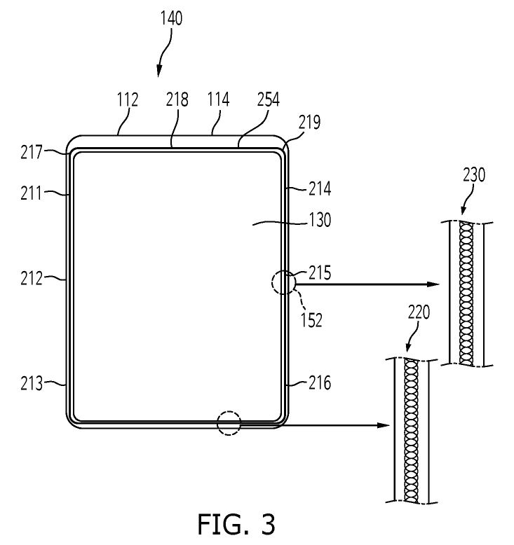

The bonding line 150 may include a venting portion 152 configured to rupture when a predetermined internal pressure of the sealed receiving portion 129 is reached. The bonding strength of the venting portion 152 may be weaker than the bonding strength of the remainder of the bonding line 150, excluding the venting portion 152. Thus, during a thermal runaway situation due to an increase in internal pressure caused by the abnormal behavior of a secondary battery, the venting portion 152 can rupture to reduce the pressure inside (or in the chamber of) the receiving portion 129. The venting portion 152 may be formed at any position where the bonding line 150 is formed. Therefore, the location of the venting portion 152 is not limited to the positioned illustrated in FIG. 1 and may be variously modified. An example will be described below with reference to FIG. 3.

According to embodiments of the present disclosure, when the body and the cover that accommodate the electrode assembly of the secondary battery are bonded by welding or by applying an adhesive, the vent may be formed by partially modifying a pattern of the bonding line 150.

FIG. 2 is a cross-sectional view illustrating a transverse section of a case for a secondary battery according to an embodiment of the present disclosure and a cross-sectional view illustrating a bonding line of the case for a secondary battery.

Referring to FIG. 2, the body 120 and the cover 130 of the secondary battery may be welded to each other so as to form the case 140 as a single joined structure. An edge or outermost region of the cover 130 may be welded to the flange portion 128 of the body 120 by a welder 160. For example, the cover 130 and the flange portion 128 may be welded to each other by laser welding. In this process, the bonding line 150 may include a welded portion 254 where the flange portion 128 and the cover 130 are welded to each other.

The welded portion 254 may be formed through welding coupling of the cover 130 and the flange portion 128. In an embodiment, the welded portion 254 may be formed on a surface between the body 120 and the cover 130 by laser welding. In this case, the welded portion 254 may have different bonding strengths depending on the positions to be welded. To achieve this, the welder 160 may be controlled to produce weld beads having different bonding strengths at different positions of the welded portion 254.

However, the joining method described above is merely exemplary, and various joining methods capable of sealing the case 140 may be used. For example, the cover 130 and the flange portion 128 may be joined to each other not only by laser welding but also by ultrasonic welding, brazing, laser brazing, welding, soldering, or the like.

FIG. 3 illustrates a case for a secondary battery according to some embodiments of the present disclosure.

Referring to FIG. 3, the welded portion 254 may be formed along an edge or an outermost region of the cover 130. The venting portion 152 may be formed at an arbitrary one of positions where the welded portion 254 is formed. For example, the venting portion 152 may be formed at one or more of a first position 211, a second position 212, a third position 213, a fourth position 214, a fifth position 215, a sixth position 216, a seventh position 217, an eighth position 218, and a ninth position 219.

The venting portion 152 may be configured to rupture when a predetermined internal pressure is reached inside the case 140. The case 140 may have an elongated rectangular shape, and when swelling occurs, the case 140 may bulge from a central region. In this configuration, when the venting portion 152 is formed at the second position 212 or the fifth position 215, the venting portion 152 may rupture at an internal pressure lower than the internal pressure at which a venting portion formed at another rupture positions. When the venting portion 152 is formed at the seventh position 217, the eighth position 218, or the ninth position 219, a rupture of the venting portion 152 may damage first and second electrode tabs 112 and 114 that are disposed adjacent thereto. Thus, when the venting portion 152 is formed at the second position 212 or the fifth position 215, the venting portion 152 may prevent thermal runaway of the secondary battery 100 more effectively than when the venting portion is formed at other positions.

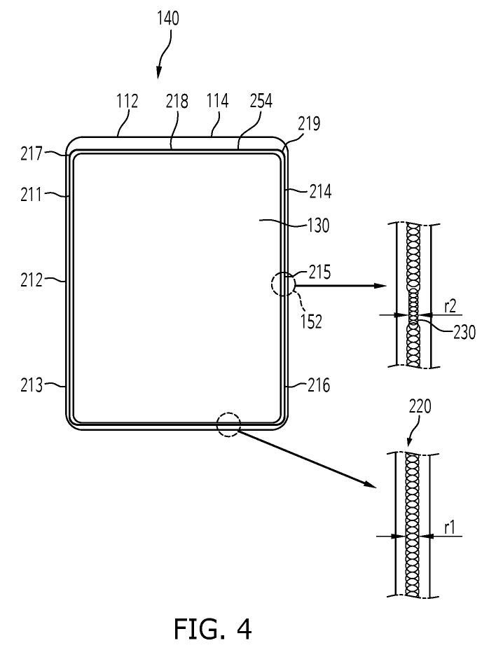

In an embodiment, a remainder of the welded portion 254 except for the venting portion 152 may include the plurality of first weld beads 220, and the venting portion 152 may include the plurality of second weld beads 230 that have a weaker bonding strength than the plurality of first weld beads 220. For example, a welding depth of each of the plurality of second weld beads 230 may be shallower than a welding depth of each of the plurality of first weld beads 220. FIGS. 4 to 6 illustrate examples of the plurality of second weld beads 230 having a weaker bonding strength than the plurality of first weld beads 220.

FIGS. 4 to 6 illustrate cases for a secondary battery according to some embodiments of the present disclosure. Descriptions of features of the cases that are the same as those described with reference to FIGS. 1 to 3 are omitted below.

Referring to FIG. 4, a diameter r2 of each of the plurality of second weld beads 230 may be less than a diameter r1 of each of the plurality of first weld beads 220. By further including the plurality of second weld beads 230 having a shorter diameter than the plurality of first weld beads 220, the venting portion 152 may be more easily ruptured, thereby effectively preventing thermal runaway of the secondary battery.

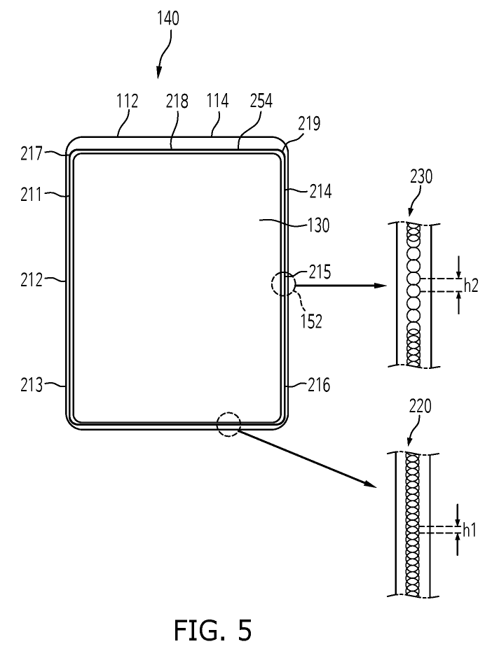

Referring to FIG. 5, an interval h2 between adjacent ones of the second weld beads 230 may be greater than an interval h1 between adjacent ones of the first weld beads 220. That is, a center-to-center distance h2 of the second weld beads 230 may be greater than a center-to-center distance h1 of the first weld beads 220. Therefore, when a section having the second weld beads 230 in the venting portion 152 is compared with a section of the welded portion 254 having the same length but including the first weld beads 220, the number of the second weld beads 230 is less than the number of the first weld beads 220 such that the second weld beads 230 may have a weaker bonding strength than the first weld beads 220.

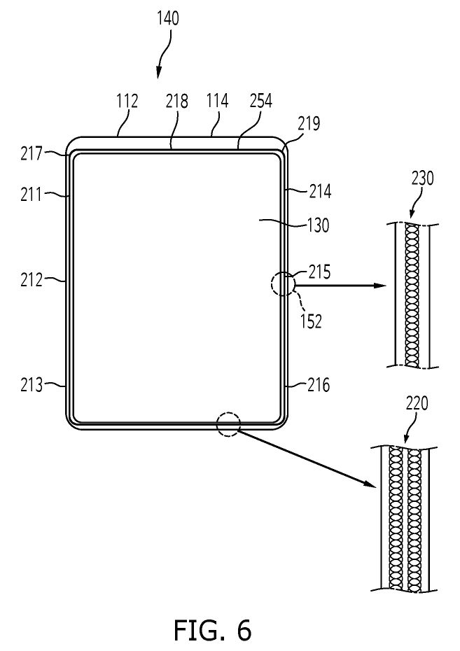

Referring to FIG. 6, the plurality of second weld beads 230 may be formed in a single row, and the plurality of first weld beads 220 may be formed in two rows parallel to each other. Therefore, the second weld beads 230 in the venting portion 152 may rupture at a lower pressure than the first weld beads 220 and thereby effectively prevent thermal runaway of the secondary battery.

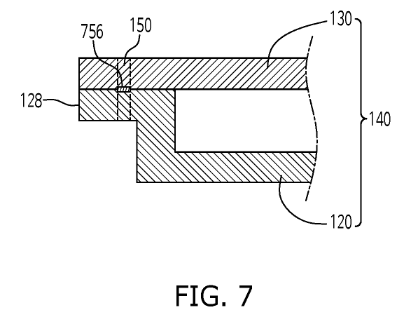

FIG. 7 is a cross-sectional view illustrating a transverse section of a case for a secondary battery according to an embodiment of the present disclosure and a cross-sectional view illustrating a bonding line of the case for a secondary battery.

Referring to FIG. 7, in an embodiment, the body 120 and the cover 130 of the secondary battery may be bonded to each other by an adhesive to form the case 140 as a single joined structure. In this process, the bonding line 150 may include an adhesive portion 756 that bonds the flange portion 128 and the cover 130 to each other. In some embodiments of the present disclosure, the adhesive portion 756 may be electrically conductive.

An adhesive used to form the adhesive portion 756 may include, for example, a metal-filled epoxy adhesive, a carbon-based conductive adhesive, a silicone-based conductive adhesive, an anisotropic conductive adhesive (ACA), or a combination thereof. However, the bonding method is not limited to these examples, and various other adhesives and bonding methods capable of sealing the case 140 may be used.

The adhesive portion 756 may be formed on a surface between the body 120 and the cover 130. The adhesive portion 756 may have different bonding strengths according to portions or positions to be bonded. To achieve this configuration, adhesives having different physical properties may be applied so that the adhesive portion 756 has different bonding strengths at different positions.

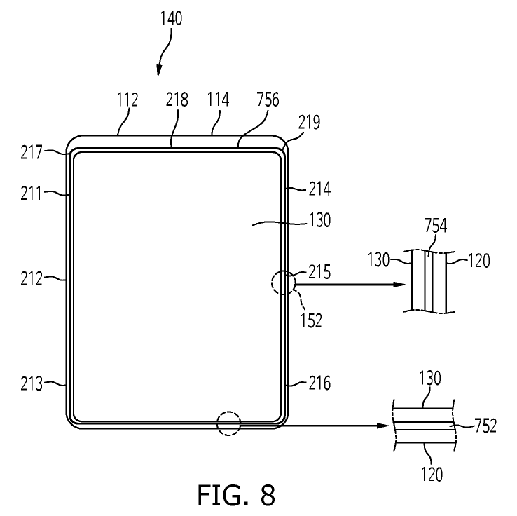

FIG. 8 illustrates a case for a secondary battery according to an embodiment of the present disclosure. Descriptions of features that are the same as those described with reference to FIGS. 3 to 6 are omitted from the description below.

Referring to FIG. 8, the adhesive portion 756 may be formed along an edge or an outermost region of the cover 130. The venting portion 152 may be formed at arbitrary positions where the adhesive portion 756 is formed. For example, the venting portion 152 may be formed at one or more of the first position 211, the second position 212, the third position 213, the fourth position 214, the fifth position 215, the sixth position 216, the seventh position 217, the eighth position 218, and the ninth position 219.

Except for the venting portion 152, the adhesive portion 756 may include a first adhesive layer 752. The venting portion 152 may include a second adhesive layer 754 that has a melting point lower than a melting point of the first adhesive layer 752. For example, a melting point of the second adhesive layer 754 may be greater than or equal to 120 °C and less than or equal to 150 °C, while a melting point of the first adhesive layer 752 may be greater than 150 °C. In specific examples, the first adhesive layer 752 may be formed of a polyimide-based conductive adhesive or a silicone-based conductive adhesive having a melting point greater than 150 °C, and the second adhesive layer 754 may be formed of a conductive hot-melt adhesive, a low-temperature curable silver epoxy, a low-temperature curable conductive polyurethane adhesive, or a combination thereof having a melting point of greater than or equal to 120 °C and less than or equal to 150 °C. The bonding method is not limited to the embodiments described above. When swelling occurs due to heat and gas generated inside the case 140, the venting portion 152 may rupture at a temperature lower than that a temperature at which a remainder of the adhesive portion 756 ruptures. Thus, thermal runaway of the secondary battery may be effectively prevented.

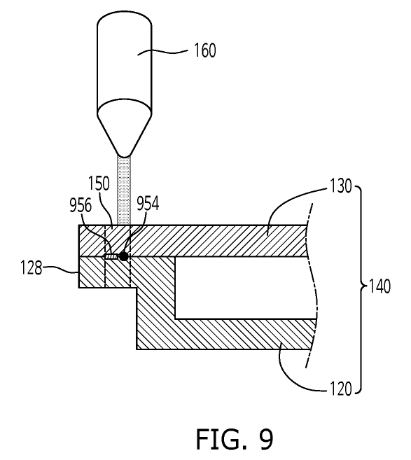

FIG. 9 is a cross-sectional view illustrating a transverse section of a case for a secondary battery according to an embodiment of the present disclosure and a cross-sectional view illustrating a bonding line of the case for a secondary battery.

Referring to FIG. 9, the bonding line 150 may include an adhesive portion 956 in which the flange portion 128 and the cover 130 are bonded to each other by an adhesive, and the adhesive portion 956 may also include a welded portion 954 in which the flange portion 128 and the cover 130 are welded to each other. The adhesive portion 956 may be the same as the adhesive portion 756 described above with reference to FIGS. 7 and 8. The welded portion 954 may be the same as the welded portion 254 described above with reference to FIGS. 2 to 6.

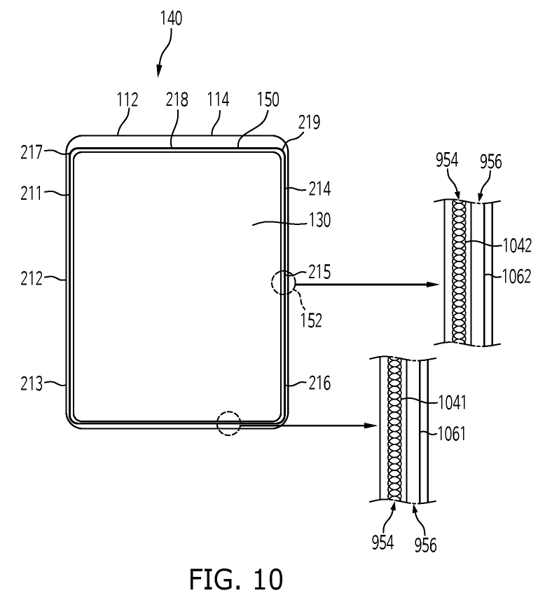

FIG. 10 illustrates a case for a secondary battery according to an embodiment of the present disclosure. Descriptions of features that are the same as or similar to those described with reference to FIGS. 3 to 6 are omitted from the description below.

Referring to FIG. 10, in the bonding line 150 according to an embodiment, except for the venting portion 152, the welding portion 945 may include the plurality of first weld beads 1041. The venting portion 152 may include the plurality of second weld beads 1042 that have a weaker bonding strength than the plurality of first weld beads 1041. Further, except for the venting portion 152, the adhesive portion 956 may include a first adhesive layer 1061. The venting portion 152 may include a second adhesive layer 1062 that has a melting point lower than that of the melting point of the first adhesive layer 1061. But in another embodiment, the second weld beads 1042 may have a weaker bonding strength than the first weld beads 1041, and melting points of the first adhesive layer 1061 and the second adhesive layer 1062 may be the same.

Accordingly, the venting portion 152 may rupture at a lower pressure and/or a lower temperature than the rest of the bonding line 150, thereby effectively preventing thermal runaway of the secondary battery.

Although not illustrated, in yet another embodiment the bonding line 152 may include the adhesive portion 956 and the welded portion 954, and the venting portion 152 may include only the adhesive portion 956. Therefore, the venting portion 152 may rupture at a lower pressure than the rest of the bonding line 150, thereby effectively preventing thermal runaway of the secondary battery.

As illustrated in FIG. 10, the welded portion 954 may be located inward of the adhesive portion 956 with respect to the case 140. When the welded portion 954 is located inward of the adhesive portion 956, a rupture pressure of the venting portion 152 may be lower than when the welded portion 954 is located outward of the adhesive portion 956 with respect to the case 140.

In a different embodiment, the welded portion 954 may be located outward of the adhesive portion 956 with respect to the case 140. When the welded portion 954 is located outward of the adhesive portion 956, a stronger pressure may be applied to the adhesive portion 956, such that the rupture pressure of the venting portion 152 is higher than when the welded portion 954 is located inward of the adhesive portion 956. Thus, by adjusting a relative arrangement of the welded portion 954 and the adhesive portion 956, the rupture pressure of the venting portion 152 may be set to meet design requirements.

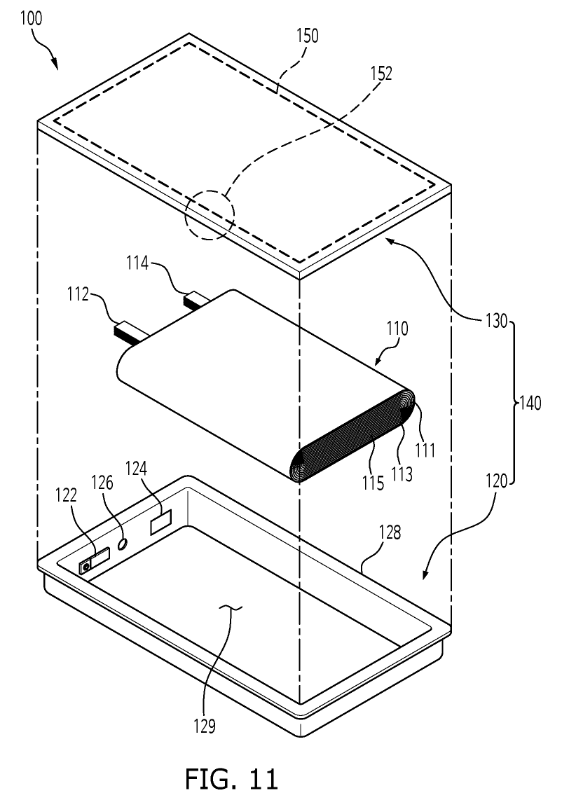

FIG. 11 is a schematic view of a secondary battery according to an embodiment of the present disclosure.

Referring to FIG. 11, a secondary battery 100 according to an embodiment of the present disclosure may include an electrode assembly 110 including a first electrode 111, a second electrode 113, and a separator 115 disposed between the first electrode 111 and the second electrode 113. The electrode assembly 110 may be accommodated in a case 140.

The electrode assembly 110 may be formed by sequentially winding or stacking the first electrode 111, the separator 115, and the second electrode 113. For example, the electrode assembly 110 may be formed in a jelly-roll state by sequentially winding the first electrode 111, the separator 115, and the second electrode 113. A cavity in which none of the first electrode 111, the separator 115, and the second electrode 113 are positioned may be formed in an inner (core) region of the jelly roll.

The first electrode 111 may correspond to a positive electrode or a negative electrode in the electrode assembly 110. The second electrode 113 may correspond to an electrode of polarity opposite to that of the first electrode 111. For example, when the first electrode 111 is a positive electrode, the second electrode 113 may be a negative electrode. Conversely, when the first electrode 111 is a negative electrode, the second electrode 113 may be a positive electrode.

The electrode assembly 110 may be impregnated with an electrolyte (not shown). The electrolyte may be a liquid electrolyte, a solid electrolyte, a gel electrolyte, or a combination thereof.

The positive electrode and the negative electrode may include a coating portion where an active material is applied to a metal foil current collector formed as a thin plate. The positive and negative electrode may also include an uncoated portion where the active material is not provided. The positive electrode and the negative electrode are wound with an insulating separator interposed therebetween. However, the present disclosure is not limited in this regard. For example, the electrode assembly described above may be configured such that positive electrodes and negative electrodes formed as a plurality of sheets are alternately stacked with the separator interposed therebetween.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause a chemical change (e.g., does not cause an undesirable chemical change in the rechargeable lithium battery) and conducts electrons can be used. Examples of the conductive material may include carbon-based materials such as natural graphite, artificial graphite, carbon black, acetylene black, ketjen black, carbon fiber, carbon nanofiber, and carbon nanotube; metal-based materials containing copper, nickel, aluminum, or silver in the form of a metal powder or a metal fiber; a conductive polymer such as a polyphenylene derivative; or a mixture thereof.

Aluminum may be used as the current collector but is not limited thereto.

The separator may include polyethylene, polypropylene, polyvinylidene fluoride, or a multilayer film of two or more layers thereof, and a mixed multilayer film such as a polyethylene/polypropylene two-layer separator, a polyethylene/polypropylene/polyethylene three-layer separator, a polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer, such as a polyolefin including polyethylene and polypropylene; a polyester including polyethylene terephthalate and polybutylene terephthalate; polyacetal; polyamide; polyimide; polycarbonate; polyether ketone; polyarylether ketone; polyether imide; polyamideimide; polybenzimidazole; polyethersulfone; polyphenylene oxide; a cyclic olefin copolymer; polyphenylene sulfide; polyethylene naphthalate; glass fiber; polytetrafluoroethylene (TEFLON®); or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The negative electrode for a rechargeable lithium battery may include a current collector and a negative electrode active material layer on the current collector. The negative electrode active material layer may include a negative electrode active material and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene-propylene copolymer, polystyrene, polyurethane, polytetrafluoroethylene, polyvinylidene fluoride, polyethylene, polypropylene, polyamideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene-propylene-diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali-metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart electrical conductivity to the electrode. Any material that does not cause an undesirable chemical change in the rechargeable lithium battery and conducts electrons can be used. Non-limiting examples thereof may include carbon-based materials such as natural graphite, artificial graphite, carbon black, acetylene black, ketjen black, carbon fiber, carbon nanofiber, and carbon nanotube; metal-based materials including copper, nickel, aluminum, or silver in the form of a metal powder or a metal fiber; a conductive polymer such as a polyphenylene derivative; or a mixture thereof.

The negative current collector may include a copper foil, a nickel foil, a stainless-steel foil, a titanium foil, a nickel foam, a copper foam, a polymer substrate coated with a conductive metal, or a combination thereof.

The secondary battery 100 illustrated in FIG. 11 may be a can-type secondary battery formed of SUS (stainless steel). But the secondary battery according to the present disclosure is not limited thereto and may be any one of various types of secondary batteries including a prismatic secondary battery formed of aluminum.

As described above with reference to FIG. 1, the case 140 may include the body 120 having the receiving portion 129 and the flange portion 128 extending from the perimeter of the open end of the receiving portion 129. The cover 130 is coupled to the flange portion 128 to seal the open end of the receiving portion 129, and the bonding line 150 disposed on the flange portion 128 and on the cover 130 corresponding to the flange portion 128. The bonding line 150 may include the venting portion 152 that ruptures when an internal pressure of the sealed receiving portion 129 reaches a certain point. The configurations of the bonding line 150 and the venting portion 152 may be the same as or similar to those of the bonding line and the venting portion described with reference to FIGS. 2 to 10.

The case 140 forms the exterior of the secondary battery 100 and may be formed of a conductive metal such as aluminum, an aluminum alloy, or nickel-plated steel. According to an embodiment, the case 140 may include a metallic material such as stainless steel (SUS) or aluminum (Al). However, these examples are illustrative, and the case 140 may be formed of various metallic materials that provide the strength and resistance to external impact required by the secondary battery 100.

In an embodiment, the secondary battery 100 may further include the first electrode terminal 122 disposed on one side surface of the body 120 and electrically connected to the first electrode 111 and the second electrode terminal 124 disposed on the one side surface of the body 120 and electrically connected to the second electrode 113.

The first electrode terminal 122 and the second electrode terminal 124 may be coupled to the body 120. For example, the first and second electrode terminals 122 and 124 may be disposed on at least one side surface of the case 140, specifically, on at least one side surface of the body 120. Positions of the first and second electrode terminals 122 and 124 are not limited to those illustrated in FIG. 11 and may be variously modified.

According to an embodiment, the case 140 may include an electrolyte injection hole 126. For example, the electrolyte injection hole 126 may be a through-hole formed in at least one side surface of the case 140 and may be formed for injecting an electrolyte into the case 140 after the body 120 and the cover 130 are joined and sealed. After the electrolyte is injected, the electrolyte injection hole 126 may be sealed with a sealing member.

The secondary battery 100 may be a lithium battery cell, a sodium battery cell, or the like. However, the scope of the present disclosure is not limited with respect to the type of battery, and the secondary battery 100 includes all batteries that can repeatedly supply electric power through charging and discharging. According to an embodiment, when the secondary battery 100 is a lithium battery cell, the secondary battery 100 has excellent cycle characteristics and high-rate characteristics and therefore may be used, for example, in an electric vehicle (EV). For example, the secondary battery 100 may be used in hybrid vehicles, including but not limited to plug-in hybrid electric vehicles (PHEV). In addition, the lithium battery cell may be used in fields requiring a wide range of power storage, for example, in smartphones, tablet PCs, electric bicycles, or electric power tools. But the present disclosure is not limited to these examples.

According to embodiments of the present disclosure, the case 140 for a secondary battery and the secondary battery 100 including the case may prevent thermal runaway due to an increase in internal pressure caused by non-ideal behavior of the secondary battery 100.

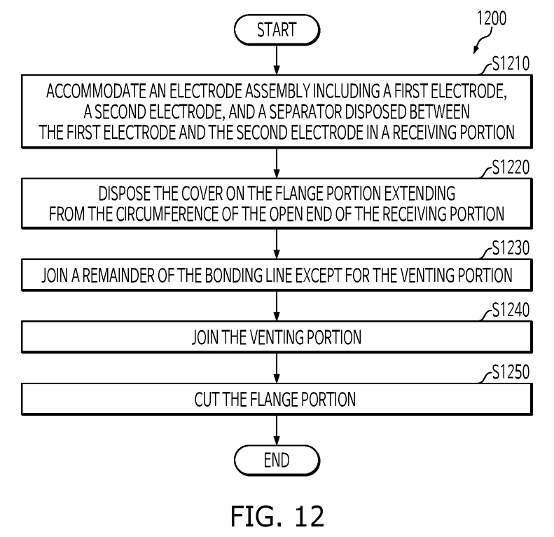

FIG. 12 is a flowchart of a method of manufacturing a secondary battery according to the present disclosure.

Referring to FIG. 12, a method 1200 of manufacturing a secondary battery may begin with step S1210 of accommodating an electrode assembly including a first electrode, a second electrode, and a separator disposed between the first electrode and the second electrode in a receiving portion.

Next, in step S1220, the cover may be disposed on the flange portion extending from the circumference of the open end of the receiving portion. For example, with reference to FIG. 1, the cover 130 may be disposed on the flange portion 128 extending from an edge of the body 120 so as to surround the receiving portion 129.

Thereafter, in step S1230, a remainder of the bonding line except for the venting portion may be joined. And, in step S1240, the venting portion may be joined. For example, with reference to FIGS. 1 and 2, after joining the bonding line 150 other than the venting portion 152, the venting portion 152 may be separately joined to complete the bonding line 150. When the bonding line 150 is completed, the body 120 and the cover 130 may form the case 140. The case 140 may be formed of a metallic material. For example, the metallic material may include stainless steel (SUS). Finally, in step S1250, the flange portion may be cut.

According to the method 1200 described above, when the body and the cover accommodating the electrode assembly of the secondary battery are joined by welding or by applying an adhesive, a vent may be formed only by partially modifying a pattern of the bonding line. In addition, the case for a secondary battery capable of preventing thermal runaway due to an increase in internal pressure caused by abnormal behavior of the secondary battery and the secondary battery including the case may be provided without an additional processing.

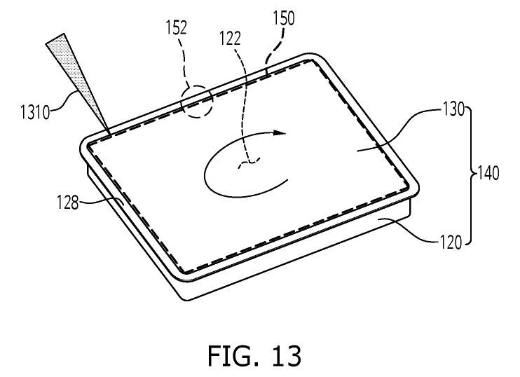

FIG. 13 illustrates a step of welding the case 140 for a secondary battery according to embodiments of the present disclosure. Descriptions of features that are the same as those described with reference to FIGS. 1 to 11 are omitted from the following description. Referring to FIG. 13, the cover 130 disposed on an upper portion of the case 140 so as to seal the receiving portion 129 may be coupled to the flange portion 128. The cover 130 may be coupled to the flange portion 128 using a fastener 1310. For example, the cover 130 and the flange portion 128 may be coupled to each other by laser welding. Additionally or alternatively, the cover 130 and the flange portion 128 may be coupled to each other by application of an adhesive. According to an embodiment, a coupling process may proceed clockwise along a line indicated by a dotted line in FIG. 13, but the present disclosure is not limited thereto.

The bonding line 150 may be formed by laser welding performed multiple times. For example, after first welding the bonding line 150 other than the venting portion 152 to form the plurality of first weld beads 220 illustrated in FIG. 3, the venting portion 152 may be welded to form the plurality of second weld beads 230 illustrated in FIG. 3. Specifically, after first welding the bonding line 150 other than the venting portion 152 to form the plurality of first weld beads 220 illustrated in FIG. 3, distances between the fastener 1310 and the secondary battery may be adjusted to weld the venting portion 152 so that the plurality of second weld beads 230 illustrated in FIG. 3 are formed.

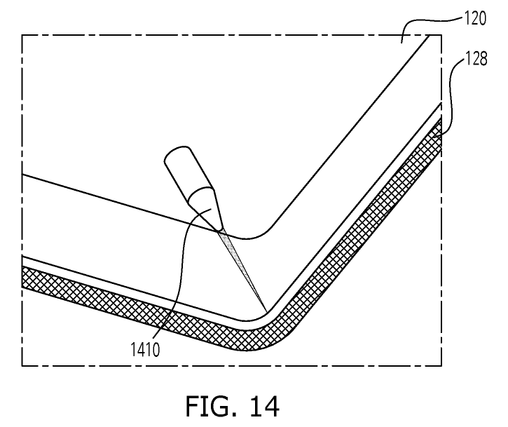

FIG. 14 illustrates a step of cutting the flange portion 128 according to e embodiments of the present disclosure. With reference to FIGS. 13 and 14, after the cover 130 is coupled to the flange portion 128 as described with reference to FIG. 13, an outermost region of the flange portion 128 that is at least a part of an outer region of the bonding line 150 may be cut. The flange portion 128 may be cut by a cutter 1410. The cutter 1410 may be, for example, a laser cutter. The flange portion 128 may be cut by an amount corresponding to a region of the flange portion 128 extending from the body 120. but the present disclosure is not limited thereto.

Although the present disclosure has been described above with respect to embodiments thereof, the present disclosure is not limited thereto. Various modifications and variations can be made thereto by those skilled in the art within the spirit of the present disclosure.

### Description of some reference symbols

120: body

128: flange portion

129: receiving portion

130: cover

140: case

150: bonding line

152: venting portion

What is claimed is:

1. A case for a secondary battery comprising:
a body including a receiving portion configured to receive an electrode assembly and a flange portion extending from a perimeter of an open end of the receiving portion;
a cover coupled to the flange portion to seal the open end of the receiving portion; and
a bonding line disposed on the flange portion and on the cover,
wherein the bonding line comprises a venting portion configured to rupture when a predetermined internal pressure is reached in the sealed receiving portion.

2. The case for a secondary battery as claimed in claim 1, wherein the bonding line comprises a welded portion where the flange portion and the cover are welded to each other.

3. The case for a secondary battery as claimed in claim 2, wherein the welded portion except for the venting portion comprises a plurality of first weld beads, and the venting portion comprises a plurality of second weld beads that have a weaker bonding strength than the plurality of first weld beads.

4. The case for a secondary battery as claimed in claim 3, wherein a diameter of each of the second weld beads is less than a diameter of each of the first weld beads.

5. The case for a secondary battery as claimed in claim 3, wherein an interval between adjacent ones of the second weld beads is greater than an interval between adjacent ones of the first weld beads.

6. The case for a secondary battery as claimed in claim 3, wherein a depth of each of the second weld beads is less than a depth of each of the first weld beads.

7. The case for a secondary battery as claimed in claim 3, wherein the plurality of second weld beads are formed in a single row and the plurality of first weld beads are formed in two rows that are parallel to each other.

8. The case for a secondary battery as claimed in claim 1, wherein the bonding line comprises an adhesive portion in which the flange portion and the cover are bonded to each other by an adhesive.

9. The case for a secondary battery as claimed in claim 8, wherein, except for the venting portion, the adhesive portion comprises a first adhesive layer, and the venting portion comprises a second adhesive layer that has a melting point lower than a melting point of the first adhesive layer.

10. The case for a secondary battery as claimed in claim 9, wherein the melting point of the second adhesive layer is 120 °C to 150 °C.

11. The case for a secondary battery as claimed in claim 8, wherein the adhesive portion is electrically conductive.

12. The case for a secondary battery as claimed in claim 1, wherein the bonding line comprises:
an adhesive portion where the flange portion and the cover are bonded to each other by an adhesive; and
a welded portion where the flange portion and the cover are welded to each other.

13. The case for a secondary battery as claimed in claim 12, wherein, except for the venting portion, the bonding line comprises the adhesive portion and the welded portion, and the venting portion comprises the adhesive portion.

14. The case for a secondary battery as claimed in claim 12, wherein, except for the venting portion, the welding portion comprises a plurality of first weld beads, and the venting portion comprises a plurality of second weld beads that have a weaker bonding strength than the plurality of first weld beads.

15. The case for a secondary battery as claimed in claim 14, wherein, except for the venting portion, the adhesive portion comprises a first adhesive layer, and the venting portion comprises a second adhesive layer that has a lower melting point than a melting point of the first adhesive layer.

16. The case for a secondary battery as claimed in claim 1, wherein the body and the cover are formed of a same metallic material.

17. The case for a secondary battery as claimed in claim 16, wherein the metallic material comprises stainless steel (SUS).

18. A secondary battery comprising:
an electrode assembly including a first electrode, a second electrode, and a separator disposed between the first electrode and the second electrode; and
a case accommodating the electrode assembly, wherein the case comprises:
a body including a receiving portion for accommodating the electrode assembly and a flange portion extending from a periphery of an open end of the receiving portion;
a cover coupled with the flange portion to seal the open end of the receiving portion; and
a bonding line disposed at the flange portion and the cover,
wherein the bonding line comprises a venting portion configured to be ruptured when a predetermined internal pressure is reached in the sealed receiving portion.

19. The secondary battery as claimed in claim 18, further comprising:
a first electrode terminal disposed on a side surface of the body and electrically connected to the first electrode; and
a second electrode terminal disposed on the side surface of the body and electrically connected to the second electrode.

20. The secondary battery as claimed in claim 18, wherein the bonding line comprises a welded portion where the flange portion and the cover are welded to each other.
